(19) United States
(12) Patent Application Publication
(10) Pub. No.: US 2006/0108518 A1
(43) Pub. Date: May 25, 2006

(54) Structure for calibrating packaging of electric micro-optic modules

(75) Inventors: James Lee, Taipei (TW); Chung-I Chiang, Taipei (TW)

Correspondence Address: LADAS & PARRY, 26 WEST 61ST STREET, NEW YORK, NY, 10023, US

(73) Assignee: NSMC HOLDINGS INTERNATIONAL CORP. LTD.

(21) Appl. No.: 10/989,182

(22) Filed: Nov. 15, 2004

(51) Int. Cl. H01J 3/14; H01J 5/16; H01J 5/02; H01J 40/14

(52) U.S. Cl. 250/239; 250/216

(57) ABSTRACT

The present invention relates to a structure for calibrating the alignment between a lens set and an image sensor in the process of packaging such as an electric micro-optic module (EMOM) or compact camera module (CCM) by using a matching structure like sawteeth or V-grooves at contact surfaces or edges. Random variations due to manufacturing process can be averaged out by a plurality of the V-grooves and high precision can be obtained by the present invention.

### BACKGROUND OF THE INVENTION

(A) Field of the Invention

The present invention relates to a structure for aligning, particularly, for optical aligning between lens set and image sensor in the process of packaging an electric micro-optic module (eMOM) or compact camera module (CCM).

(B) Description of Related Art

An electric micro-optic module (eMOM) is a structure comprising a lens set and an image sensor, wherein the lens set collects exterior light and forms image on the image sensor within the eMOM. It is apparent that alignment of the lens set and the image sensor is very important in packaging the eMOM since image quality will be severely reduced in misalignment.

U.S. Pat. No. 6,759,687 by Miller, David B. et. al. disclosed a passive alignment method using the surface tension of solder bumps. This alignment process has the following drawbacks. First, it aligns the translational errors in the packaging plane only. For most optical modules, the optical performance is more sensitive to tilting or rotational error. Second, surface tension depends greatly on the solder area, solder materials, contact surface conditions, and temperature. Direction and seriousness of misalignment are, however, random in nature, which may not be completely solved by this method.

### SUMMARY OF THE INVENTION

The present invention relates to a structure in sealing edges of eMOM packaging. A typical eMOM comprises a lens holder and a sensor mount, and the lens holder and sensor mount together form a closed space therein. An image sensor is then placed inside the closed space. A lens set, which is on the lens holder, relays light from exterior to the image sensor within the closed space. Normally, the lens set is installed in a penetrating hole of the lens holder so as to transmit light from outside.

According to the structure of the invention, the contact edges of the lens holder and the sensor mount is provided in the form such as sawteeth or V-grooves. The structure will be located both on the corresponding sides of the lens holder and the sensor mount (“optically coupled modules”) but does not necessarily cover all the contact surfaces. The V-groove surface is used to align the contact surfaces passively for two optically coupled modules after contact. V-grooves have the property of passive alignment due to the gradually tapered contact surfaces in kinematics coupling, which forces the position of related modules to be aligned by the packaging load. The precision of such kind of matching relies on the precision of the pitch of the v-grooves as well as its positioning accuracy provided that enough packaging forces being applied. V-grooves with an pitch accuracy of ±0.5 um can be manufactured in volume for photonic devices and a combined pitch precision less than 10 um for the optically coupled modules can be obtained accordingly. In practice, the combined pitch precision can achieve a level of 0.5 um. Said “accuracy” or “precision” of v-grooves means dimensional difference between adjacent grooves, such as distance between grooves, height of groove, etc and usually being called as pitch accuracy or pitch precision. The relative error or lateral shift between the contact surfaces is averaging out among the grooves, since the pitch variation is random in nature. Accordingly, if individual precision tolerance of the pitch of each of adjacent grooves lies within certain range, the combined tolerance is decreasing with increasing number of grooves.

### BRIEF DESCRIPTION OF THE DRAWINGS

The present invention is described below by way of example with reference to the accompanying sole drawing which will make it easier for readers to understand the purpose, technical contents, characteristics and achievement of the present invention, wherein:

FIG. 1 is an exploded view of the eMOM comprising the structure according to the present invention.

### DETAILED DESCRIPTION OF THE INVENTION

The detailed description of the preferred embodiment respect to the appended figure is intended to describe the present invention, and is not intended to limit forms to embody the present invention.

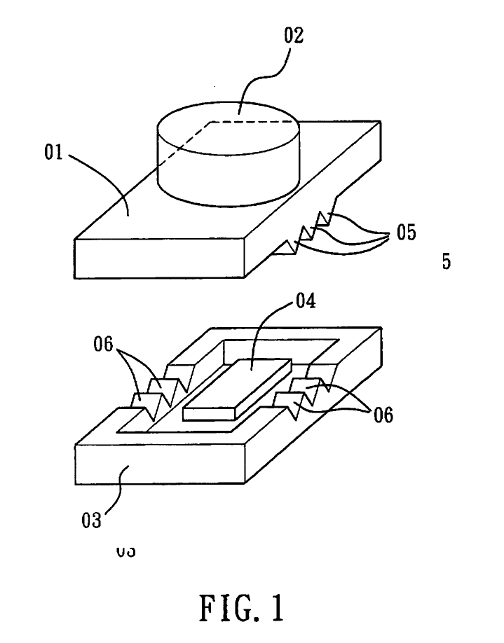

Please referring to FIG. 1, a structure for packaging of an electric micro-optic module comprising a lens holder 1 for holding a lens set 2, and a sensor mount 3 for holding an image sensor 4, the structure comprising:

A first matching structure 5 located on the lens holder 1; and

A second matching structure 6 located on the sensor mount 3,

wherein the lens holder 1 and the sensor mount 3 are designed to form a closed space therein and said first matching structure 5 and second structure 6 are at contact edges thereof, and wherein said contact edges are predetermined to be matched in a limited range of precision. In this embodiment, the first matching structure 5 and second matching structures 6 are in the form of a sawteeth or v-grooves and cover only part of the contact surfaces or edges. Alternatively, said “first matching structure” or “second matching structure” can be distributed on the contact surfaces or edges in at least one group. In this embodiment, both the first and second matching surfaces are separated in two groups which are located on opposite sides on said optically coupled module. (the other side of the first matching structure 5 is covered by the lens holder 1 and cannot be seen from the figure) The limited range of precision means average dimensional variation between adjacent sawteeth or V-grooves, which is around or smaller than ±0.5 um.

1. A structure for packaging of an electric micro-optic module comprising a lens holder holding a lens set and a sensor mount holding an image sensor, the structure comprising:
a first matching structure located on the lens holder;
a second matching structure located on the sensor mount; and
wherein the lens holder and the sensor mount are designed to form a closed space therein and said first matching structure and second structure are at contact edges thereof, and wherein said contact edges are predetermined to be matched in a limited range of precision.

2. The structure as claimed in claim 1, wherein the first matching structure and second matching structures are in the form of sawteeth or V-grooves.

3. The structure as claimed in claim 1, wherein the first matching structure and the second structure cover part or all of the contact edges.

4. The structure as claimed in claim 3, wherein the first matching structure or the second matching structure is distributed on the contact edges in at least one groups.

5. The structure as claimed in claim 2, wherein the first matching structure and the second structure cover part or all of the contact edges.
